(19) United States
(12) Patent Application Publication
(10) Pub. No.: US 2019/0262664 A1
(43) Pub. Date: Aug. 29, 2019

(54) CREATING CUSTOMIZED ADAPTIVE WORKOUT PROGRAM

(71) Applicant: Nicholas Edward Schindler, Covington, OH (US)

(72) Inventor: Nicholas Edward Schindler, Covington, OH (US)

(21) Appl. No.: 16/283,142

(22) Filed: Feb. 22, 2019

Related U.S. Application Data
(60) Provisional application No. 62/634,410, filed on Feb. 23, 2018.

(51) Int. Cl. A63B 24/00; G09B 5/04; G09B 5/06; G06N 5/04

(52) U.S. Cl. CPC A63B 24/0075; A63B 24/0062; G09B 5/04; G09B 5/065; G06N 5/04; A63B 2220/803; A63B 2024/0065; A63B 2230/65; A63B 2230/30; A63B 2230/06; A63B 2220/836

(57) ABSTRACT

A process for creating an adaptive workout program comprises receiving physical characteristic information about a person via a user interface and receiving goal information via the user interface. Using artificial intelligence running on a processor and interacting with an electronic database, an adaptive workout program is determined based on the physical characteristic information and the goal information. Instructions for the workout program are retrieved and displayed. Before, during, or after the person performs the workout program, feedback is received and used to update the workout program.

### CROSS REFERENCE TO RELATED APPLICATIONS

This application claims the benefit of U.S. Provisional Patent Application Ser. No. 62/634,410, filed Feb. 23, 2018, entitled ARTIFICIAL INTELLIGENCE ALGORITHM AND PROCESS THAT SIMULATES A PERSONAL TRAINER TO CREATE CUSTOM WORKOUTS, the disclosure of which is hereby incorporated herein by reference.

### BACKGROUND

Various aspects of the present invention relate generally to creating a workout program and more specifically to an adaptive workout program that adapts to circumstances such a s limited equipment, injuries, mobility restrictions, etc.

People are working out more and more in recent years to reach different workout goals (strength, sculpting, weight loss, etc.). However, people may not know which exercises help with achieving a workout goal. Current solutions provide a “one workout fits all” solution that assumes all people are the same. Even if the current workouts are geared toward for a specific workout goal, the person implementing the goal is not the same.

### BRIEF SUMMARY

According to aspects of the present invention, a process for creating an adaptive workout program comprises receiving physical characteristic information about a person via a user interface and receiving goal information via the user interface. Using artificial intelligence running on a processor and interacting with an electronic database, an adaptive workout program is determined based on the physical characteristic information and the goal information. Instructions for the workout program are retrieved and displayed. Before, during, after, or combinations thereof the person performs the workout program, feedback is received and used to update the workout program.

### BRIEF DESCRIPTION OF THE SEVERAL VIEWS OF THE DRAWINGS

FIG. 1 is a flow chart that illustrates a process for creating an adaptive workout program, according to various aspects of the present disclosure;

FIG. 2 is a block diagram illustrating a system for creating an adaptive workout program, according to aspects of the present disclosure;

FIG. 3 is a combination block diagram and flow chart that illustrates components and subprocesses of the processes described herein, according to aspects of the present disclosure;

FIG. 4 is an illustration of a database, according to aspects of the present disclosure;

FIG. 5 is a block diagram of a distributed network system, according to aspects of the present disclosure; and

FIG. 6 is a block diagram of a processing device, according to aspects of the present disclosure.

### DETAILED DESCRIPTION

A process is provided herein that creates a workout program for a person to achieve a physical goal. Basically, physical characteristic information about the person is supplied to the process along with the goal. Based on using the physical characteristic information as a starting point and the goal information as an ending point, a workout program is determined for the person. For example, an initial list of exercises tuned to the person is created (e.g., from a set of rules) and displayed to the user. This workout program (i.e., the list of exercises) is modified over time (i.e., adaptive) using artificial intelligence and feedback from the person to help the person realize the goal.

In some embodiments, the process includes receiving injury information about the person. This injury information is also used to determine the initial set of exercises (herein also referred to a list of exercises) and/or to help modify the set of exercises when updating the workout program.

In various embodiments, the process includes receiving the physical characteristic information as an image of the person and the goal as a modified image of the person. The modified image may be a result of processing the received image through a program that allows the person (or other user) to alter the way the person looks in the image. The differences between the image and the modified image may be used to help determine the workout program.

The present disclosure provides several advantages over existing solutions. For example, existing workout programs are not tuned for a particular individual. Using the processes and systems described herein, a workout program may initially start with a first set of exercises and end with a modified set of those exercises (or different exercises). Further, if a person is traveling and does not have access to similar equipment that they normally have access to, the workout program can adapt to such circumstances. Moreover, if the person gets injured either during the workout or away from the workout, the workout program may be adapted to provide less stress on injured areas. After adapting, the resulting instructions for the workout program are custom made to flow from one exercise to the next (i.e., a custom workout video is made after adapting). Further, the adaptive nature uses feedback to find each individual person's threshold to properly manage stress on the person's central nervous system and cortisol management to realize a maximal workout without pushing the person beyond limits, which minimizes injury and maximizes recovery. Moreover, workout programs may be customized and adapted to fit specific positions in sports (e.g., a program for a male inside linebacker will be different from a program for a female volleyball player). Also, the use of sensors to measure perspiration will help indicate if an exercise is too strenuous or not strenuous enough, which assists in measuring actual calories burned by each individual person versus using established tables that estimate calories burned based on variables like height and weight.

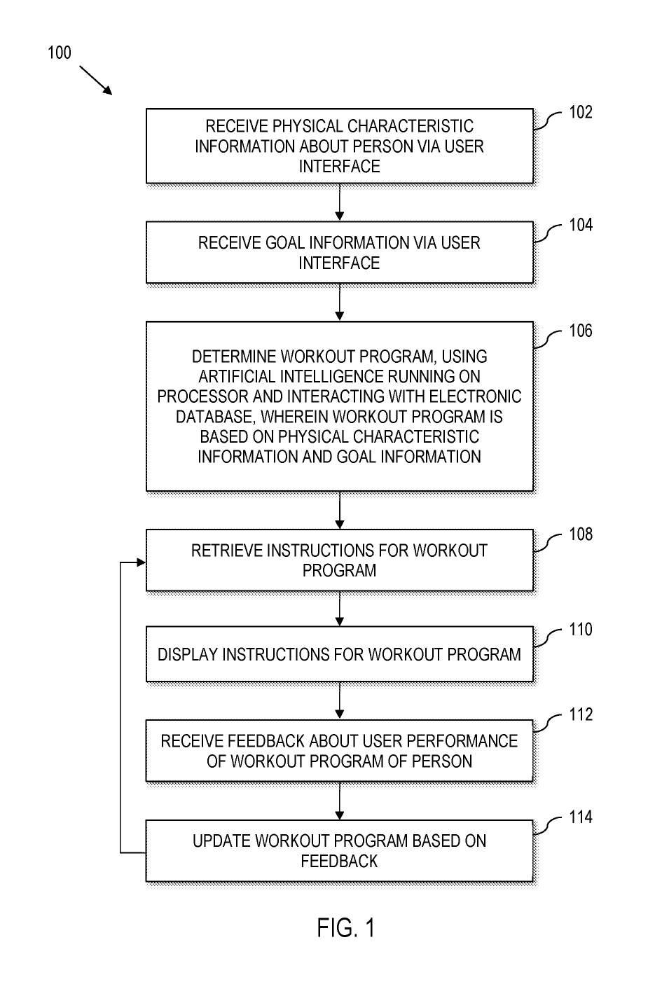

Turning now to the figures, and in particular to FIG. 1, a process 100 is shown for creating a customized workout program, where the workout is fit to the person as opposed to trying to fit a person to a pre-made workout program. At 102, physical characteristic information is received via a user interface (e.g., text, graphical user interface (GUI), etc.). For example, if the process 100 is running on a remote server, the user interface may be running on a local processor (e.g., a client computer, a smartphone, a tablet, any device with network access, etc.). The physical information may include information associated with the person's height, weight, age, gender, body fat, etc., or combinations thereof. Moreover, physical characteristic information can include whether the person is a beginner, intermediate, advanced, elite, etc. when it comes to working out. Further, the physical characteristic information may include injury-related information, mobility restrictions, etc. or combinations thereof. For example, if the person has an ankle sprain, then such information may be useful when determining a workout program to limit stress on the ankle until the ankle is healed.

In some embodiments, receiving physical characteristic information about a person via a user interface includes receiving an image of the person. For example, if the user interface is running on a device that includes a camera (e.g., smartphone, tablet, etc.), then the device may be used to take a photograph of the person to be sent to the remote server. The server (or in some embodiments, the device with the camera) then extrapolates the physical characteristic data from the image. For example, the server can determine height, weight, body mass index, body fat, etc. or combinations thereof via image processing on the image.

At 104, the process 100 includes receiving goal information via the user interface. For example, a user (who may be the same as the person with whom the physical information is associated or a different person) inputs a desired goal, such as a target weight, a target body fat count, etc. In some embodiments, the goal may be a little more generic and include a goal of getting better muscle tone, generating more muscle, upper body work, improve strength, cardiovascular improvements, etc. In various embodiments, the user can select body-type goals from different body types including, but not limited to: healthy, lean, and toned; toned and muscular; athletic/performance; athletic/strength; muscular; defined; shredded; etc.

In numerous embodiments, the goal may be a modified image of the person. For example, in embodiments where the physical characteristic information is received as an image, the goal information may be a modified image. For example, a user may manipulate an image using image-manipulation software (on the device, on the server, or both). The process can then derive the goal information from the modified image. In some embodiments, the goal information may be an image of a second person whom the person associated with the physical characteristic information wants to emulate.

Further, the process 100 may receive other information. For example, the process 100 may receive sporting information about the person (e.g., a sport and a position played in the sport). For example, if the person plays offensive line in football (instead of wide receiver), then such information may be relevant to a workout program. The program 100 takes injury prevention into consideration when creating a workout program based on a sporting position. For example, if offensive linemen have a higher risk of ankle injury, then the workout program will include exercises that strengthen the ankle.

As another example, the process may receive information about what equipment the person has access to. For example, if the person has exercise bands but does not have free weights, then such information may be relevant to a workout program.

As a further example, the process may include receiving availability information. For example, the user may enter information about when the person is available for working out, times per week the person wants to workout, etc. or combinations thereof. Thus, even though a person has four time slots available per week to workout, the availability information may limit that to three times working out, where the program can choose which three of the four available times to use for a workout program for the person. Further, the availability information may include a set time period to achieve the goal (e.g., four weeks, six months, etc.). Moreover, information about a prolonged absence from exercising may be entered.

At 106, the process includes determining a workout program, using artificial intelligence running on a processor and interacting with an electronic database, wherein the workout program is based on the physical characteristic information and the goal information. Thus, the artificial intelligence may identify a variable with the received physical characteristic information that must be changed to achieve the received goal information. For example, if a person wants to lower weight, then the variable may be body fat count. Further, a first exercise may be determined from the database that modifies the identified variable. For example, some exercises build muscle, which adds to weight, while other exercises improve caloric burn, which helps reduce body fat. Other exercises that help the person achieve the goal are then added to a list (i.e., set) of exercises as the workout program.

Based on the variables and rules (e.g., if-then relationships, fuzzy logic, etc., or combinations thereof), the process creates the list of exercises (or updates the list of exercises, as discussed below) for the workout program as discussed herein.

The electronic database includes many exercise entries, where each exercise entry includes a name of the exercise, instructions associated with the exercise (video, audio, textual, or combinations thereof), and variables for selecting the exercise as an exercise to add to the workout program. Thus, an exercise may be used for fat burning while others will not. Another example of a variable is whether or not the exercise requires equipment (e.g., machines, bands, free weights, etc.). Further, there may be a variable for whether or not the exercise may be used when there is an injury or mobility restriction on a body part. Moreover, the variable for an exercise may include results of number of repetitions (reps), sets, time between sets, etc., or combinations thereof. Still further, the variables may include alternatives for certain exercises. As a further example, the variables may associate an exercise with a certain sport or position within a sport. The database further includes a set of rules that indicate which variables to use for certain exercises, and which exercises or combinations of exercises produce which results (goals).

The database may categorize the exercises by type. For example, the exercises may be divided as follows: upper body (chest, back, triceps, biceps and shoulders), lower body (squat, hinge, lunge, calf, hamstring, hip and glute dominate), core (plank, rotational, frontal and low back), cardio (alactic, anaerobic, and aerobic) and mobility (self-myofascial release (SMR), stretching and active stretching). Subcategories are indexed per primary category that include factors of ongoing exercises versus one-time exercises. Exercises are affiliated with being friendly or unfriendly per mobile restriction/injury to make selections of exercises that do not conflict with an individual's mobile restrictions/injuries.

While the database includes exercises at the start, a user may supply custom exercises to the database. The user enters the custom exercise through the interface (or uploads using the user interface) and the process identifies variables associated with the custom exercise and adds the custom exercise to the database for future use.

The artificial intelligence picks the initial set of exercises and transmits the list for display. In some embodiments, the initial set of exercises (i.e., the workout program) is displayed through the user interface. The person (or other user) may choose to remove or replace an exercise in the list by using an override modification via the user interface. In several embodiments, the person may reorder the exercises in the list using the override modification.

In embodiments that include receiving sporting information, the sporting information is used to determine the workout program as well. Further, in embodiments that include receiving equipment access information, the equipment access information is used to determine the workout program as well. Moreover, if availability information is received, then the availability information is used to determine the workout program. For example, the workout program may be completed in a certain period of time using only certain days/times for the person to work out. Still further, if prolonged absence information is received, then the prolonged absence information is used to determine the workout program (e.g., ease the person back into working out).

Once specific exercises are selected, the process factors the variables to determine frequency (the number of times in the set period that specific exercises occur in the workout plan) such as how many times push-ups will occur for primary category upper body, subcategory chest. Next, the process factors the variables and exercises selected to determine the number of sets, repetitions, weight (such as 20-pound dumbbells) and rest (how much time a person rests in between sets). Thus, a workout program may be divided up into segments (what to do per session), exercises (which exercises to do at each segment), sets per exercise, and reps per set.

Further, is several embodiments, the process 100 may take phases of training into account. For example, the phases may be preparatory, strength, hypertrophy, hypertrophy/strength, maximum strength, power, and deload. The exercises and the order of the exercises will depend on the phases as well. The phases may all be present in one workout session or broken up among several weeks of the workout program.

At 108, the process 100 includes retrieving instructions for the workout program. As mentioned above, the exercises in the database include instructions for the exercises. These instructions may be in any form and format (e.g., audio, video, textual, etc., or combinations thereof). The instructions for each exercise of the workout program are concatenated to create instructions for the workout program in general. For example, if there are video instructions available, then the video instructions are concatenated to create a custom workout video for the person. In numerous embodiments, the instructions include teaching proper technique to perform the exercise.

At 110, the process 100 includes displaying the instructions for the workout program to the person. For example, in a system with video instructions and a video display, the concatenated video instructions are shown to the person via the video display. In some embodiments, where there is no video display available to the person, then audio instructions are displayed by sending the audio instruction to speakers (e.g., ear buds, headphones, box speakers, etc., or combinations thereof). The audio instructions may be sent wirelessly or over a wired network. Further, music may be added to the instructions.

At 112, the process 100 includes receiving feedback about a performance of the workout program of the person. Thus, when the person performs the workout, that person's performance is fed back to the process 100, as discussed herein. In several embodiments, the feedback may be entered by the person via the user interface. For example, the person may provide feedback indicating that a certain exercise is too hard (too strenuous), too easy (not strenuous enough), just right, hurts a certain body part, want more, want less, etc. or combinations thereof. For example, if a person would prefer more cardio, then after an exercise, the user may indicate so (e.g., say “want more” into a microphone of the device, select a button via a graphical user interface, etc.). As another example, if the person prefers more cardio, then after the workout program completes, the user may indicate that s/he wants more cardio overall.

In some embodiments, the feedback is received from sensors coupled to the person. The sensors may be coupled in any way and may also be part of a smartwatch or other wearable device that includes sensors (e.g., blood pressure, heart rate, accelerometers, sweat sensors, etc., or combinations thereof).

The feedback may also be information that occurred outside of the exercise program. For example, if the person suffered an injury between sessions, then the feedback may be an indication of that injury. As another example, feedback can be that a piece of equipment that is normally available is not available (e.g., the equipment is broken, there is a long line, etc.), then the program 100 will not issue an exercise for that piece of equipment for that session and may recommend an alternative exercise.

At 114, the process 100 includes updating (i.e., adapting) the workout program based on the feedback. For example, if an exercise is too strenuous (e.g., because the person indicates so, the sensors indicate that the person is struggling dangerously, or both), then the process 100 will identify a less strenuous exercise from the database based on the feedback. On the other hand, if an exercise is too easy (e.g., because the person indicates so, the sensors indicate that the person is not having a hard time at all, or both), then the process 100 will identify a more strenuous exercise from the database based on the feedback. The new exercise may be added to the workout program anywhere in the order and may replace the exercise that was not suitable.

In embodiments where sensors are used for the feedback, a variable associated with the received physical characteristic information may be identified that must be changed to achieve the received goal information. Then, an exercise is identified that modifies the identified variable (as discussed above). The new exercise may be added to the workout program anywhere in the order and may replace the exercise that was not suitable. Further, the person may change workout goals and provide new goal information as feedback. If so, then such feedback may also be used to update the workout program.

In various embodiments, the workout program is updated by changing an order of the exercises instead of adding/replacing/removing an exercise. In numerous embodiments, the updated workout program may include the same exercises, but use different weights for those exercises (e.g., use fifteen-pound dumbbells instead of twenty-pound dumbbells if the exercise was too strenuous.).

When the person performs a next iteration of the workout program (e.g., on the next day), then the updated workout program is used, and the process 108 loops back to 108 provide instructions for the updated exercise list of the workout program.

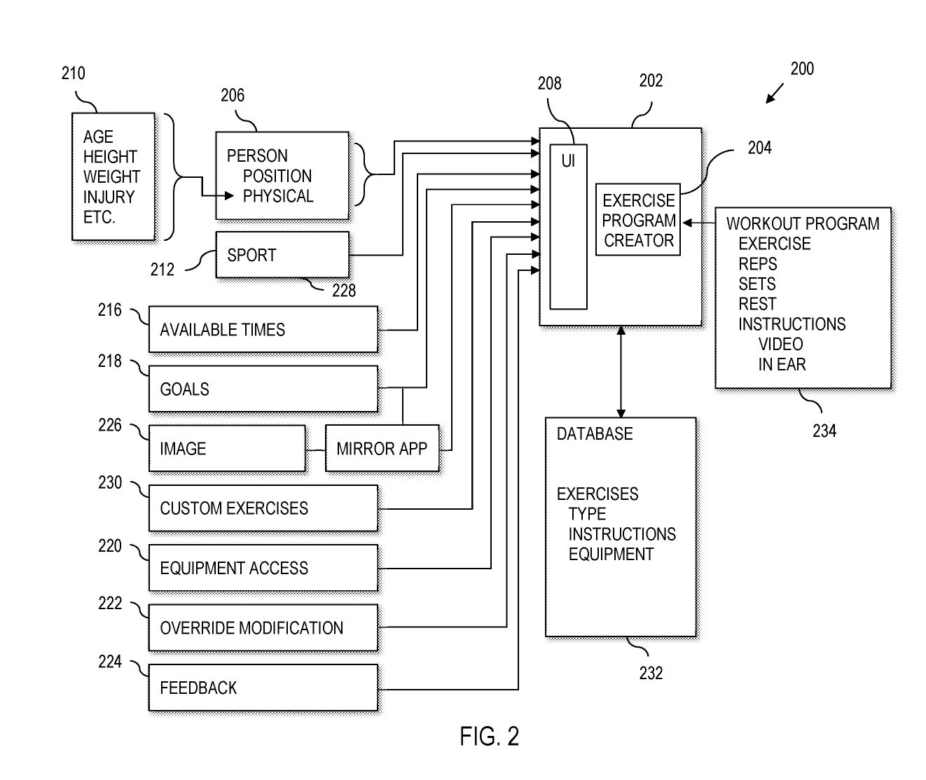

Turning now to FIG. 2, a block diagram 200 of aspects of the present disclosure is shown. A processor 202 runs the unconventional process 204 (100, FIG. 1) described above. The processor 202 may be on a remote server, local to the user interface, or be multiple processors, as discussed below. The processor accepts information from many different sources. For example, a person's information 206 may be entered via a user interface (UI) 208. The user interface may be textual, graphical, audio (e.g., microphone), etc., or combinations thereof. The person's information 206 may include physical characteristics 210 including age, height, weight, injury information, gender, etc. Further, the person's information 206 may include information about a position in a sport 212 that the person plays. As described herein, the “person” is the entity for whom the adaptive workout program is customized. The person will be performing the workout program. A user is someone entering the information and may be the same entity as the person or a different entity.

Further, the processor 202 accepts available time (availability) information 216, goal information 218, equipment access information 220, override modifications 222, feedback 224 tied to performance of the workout program, etc.

As discussed above, the physical characteristic information may be supplied or supplemented by an image 226. Further, the process 202 may run, externally (as shown) or internally, a “mirror application” 228 that allows a user to modify the image based on the person's goals. For example, the image 226 may be displayed to the user who may then use image-editing software to modify the image 226 free form to create a modified image that is accepted by the process 202. The process 202 can then use the modified image to extrapolate goal information. Moreover, the user may enter the image 226 and goal information 218 separately, and the process 202 can update the image based on the goal information to show the user what the image will look like based on the goal information 218. Thus, the image 226 may be modified directly via image-editing software, based on the goal information, or a combination thereof.

As discussed above, a user may enter custom exercises 230 for storage in the database 232. The information stored about the exercises and custom exercises 230 in the database 232 includes type of exercise, instructions, associated equipment, rep/set information, goal-type information, etc.

Based on the received inputs and the exercises in the database 232, the program 202 creates a customized adaptive workout program 234, as described above. The workout program includes exercises, instructions, reps, sets, rest, etc.

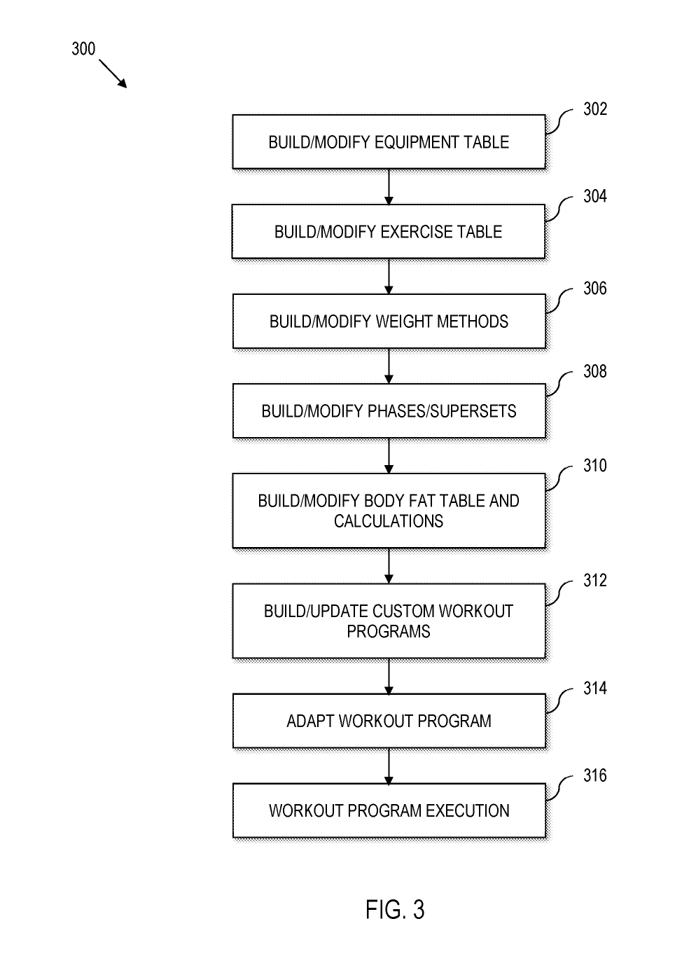

Turning now to FIG. 3, a flow chart and block diagram 300 is shown that illustrates aspects of the present disclosure. The boxes shown may be in any desired order. An equipment manager 302 allows a user to enter information about different types of equipment (e.g., dumbbells (weight), exercise bands, heavy bags, machines, etc.). The equipment information may include types of exercises that the equipment may be used for, options associated with the equipment (e.g., resistance, weight, weight increments, minimum/maximum weight, specific body areas, mobility information, etc.). The equipment manager allows a user to build and modify an equipment table for use of the processes described herein. Further, the equipment table may be stored in the database (230, FIG. 2).

An exercise builder 304 allows for a user to enter and manage exercises. For example, as discussed above, a user may enter custom exercises. The exercises are actions that may be taken by the person using equipment or without equipment. Information associated with the exercises may include instructions, body area targeted, goal targeted, injury cautions, equipment required, etc. Thus, the exercises are stored in a table that is part of the database.

A rules builder 306 allows a user to build rules (that are adaptive themselves based on feedback) for determining and updating the workout program. Thus, there are rules for applying exercises, equipment, and methods based on goals and physical characteristics, among additional information as well. Thus, these rules may be used to create a customized workout program for an individual person. Then based on feedback (sensors, inputs, change in physical characteristics, injuries, etc.) and the rules, the customized workout program may be adapted to meet the goals of the person.

A person/user manager 308 allows users to manage person-specific data such as vital signs, images, membership information, profiles, name, identification, address, etc.

A body-fat engine 310 uses images to calculate a person's body fat percentage and modified images to calculate a goal body fat percentage. The user may also override the determined body fat percentage if desired or enter a body fat percentage if an image is not available.

The tables listed above are modifiable by the user, but they may also be adaptive based on feedback. For example, if it is found that an exercise causes injuries when performed by a person with a certain mobility restriction, then that information may be added to the exercise in the exercise table. As another example, the rules table may also be adaptive when it is found (based on feedback) that an exercise that was not thought to improve a variable actually does improve that variable.

A program builder 312 (e.g., 106 of FIG. 1) creates the workout program as discussed above.

An exercise optimizer 314 (114 of FIG. 1) updates the workout program, as discussed above.

A workout program executor 316 displays the set of exercises to the user and allows for override modifications. Further, the instructions associated with the exercises are displayed. Time and feedback information are stored for use in adapting the workout program.

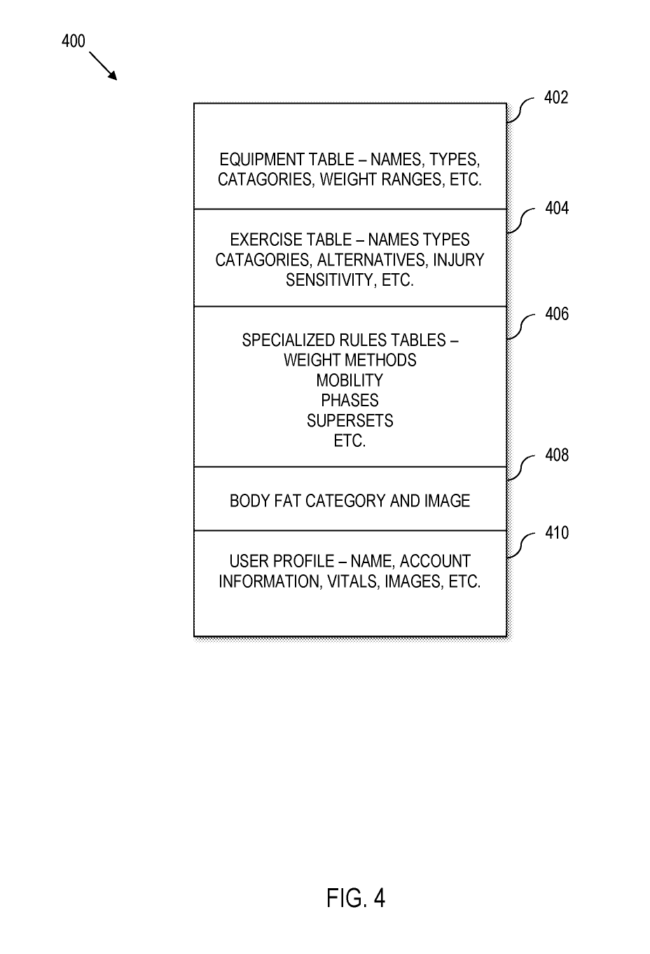

FIG. 4 illustrates a sample database 400 that includes information in tables. For example, the database 400 of FIG. 4 includes an equipment table 402 that includes names of equipment, types of the equipment, categories of equipment, weight ranges, weight increments, etc. Further, the database 400 includes an exercise table 404 that includes names of exercises, types of exercises, categories of exercises, alternatives for exercises, injury sensitivity, instructions, etc. Moreover, the database 400 includes a rules table 406 that looks at phases, methods, exercises, mobility restrictions, supersets, etc. The database 400 also includes a body fat table and image table 408. Additionally, the database 400 includes a user profile table 410 that stores information such as name, account, vitals, images, etc.

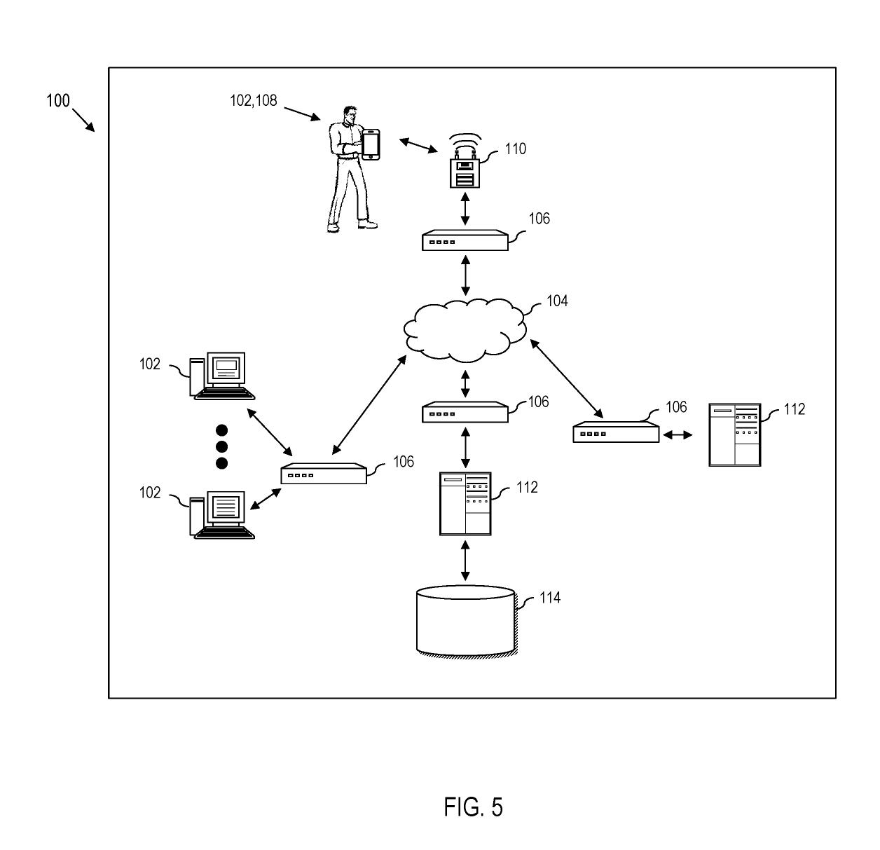

Turning now to FIG. 5, a system 500 is shown that can support the processes, diagrams and systems described herein. The illustrated system 500 is a special purpose (particular) computing environment that includes a plurality of hardware processing units (designated generally by the reference 502) that are linked together by one or more network(s) (designated generally by the reference 504).

The network(s) 504 provides communications links between the various processing units 502 and may be supported by networking components 506 that interconnect the processing units 502, including for example, routers, hubs, firewalls, network interfaces, wired or wireless communications links and corresponding interconnections, cellular stations and corresponding cellular conversion technologies (e.g., to convert between cellular and TCP/IP, etc.). Moreover, the network(s) 504 may comprise connections using one or more intranets, extranets, local area networks (LAN), wide area networks (WAN), wireless networks (WiFi), the Internet, including the world wide web, cellular and/or other arrangements for enabling communication between the processing units 502, in either real time or otherwise (e.g., via time shifting, batch processing, etc.).

A processing unit 502 can be implemented as a server, personal computer, laptop computer, netbook computer, purpose-driven appliance, special purpose computing device and/or other device capable of communicating over the network 504. Other types of processing units 502 include for example, personal data assistant (PDA) processors, palm computers, cellular devices including cellular mobile telephones and smart telephones, tablet computers, an electronic control unit (ECU), a display of the industrial vehicle, etc.

Still further, a processing unit 502 can be used by one or more users 508 (noting that the user is not a component of the network itself. In the example configuration illustrated, the various components herein can wirelessly communicate through one or more access points 510 to a corresponding networking component 506, which serves as a connection to the network(s) 504. Alternatively, the users 508 operating processing units 502 equipped with WiFi, cellular or other suitable technology allows the processing unit 502 to communicate directly with a remote device (e.g., over the network(s) 504).

The illustrative system 500 also includes a processing unit implemented as a server 512 (e.g., a web server, file server, and/or other processing unit) that supports a data source 514, as described above.

In an exemplary implementation, the data sources 514 includes a collection of databases that store various types of information related to the process described above. As described in greater detail herein, data can be embodied as a data set that is entirely within a digital structure such as a traditional hardware database, binary large object (BLOB) storage, remote (“cloud”) storage, representational state transfer (REST) storage, etcetera. Alternatively, or even simultaneously, data can be associated with (or embodied within) a physical device such as data reflecting hardware specifications (number of USB ports, operating system version, etc.), for example. However, these data sources 514 need not be co-located.

The processes described herein may be run on a client 502 entirely, on a server 512 entirely, or be broken up between any number of clients 502 and servers 512.

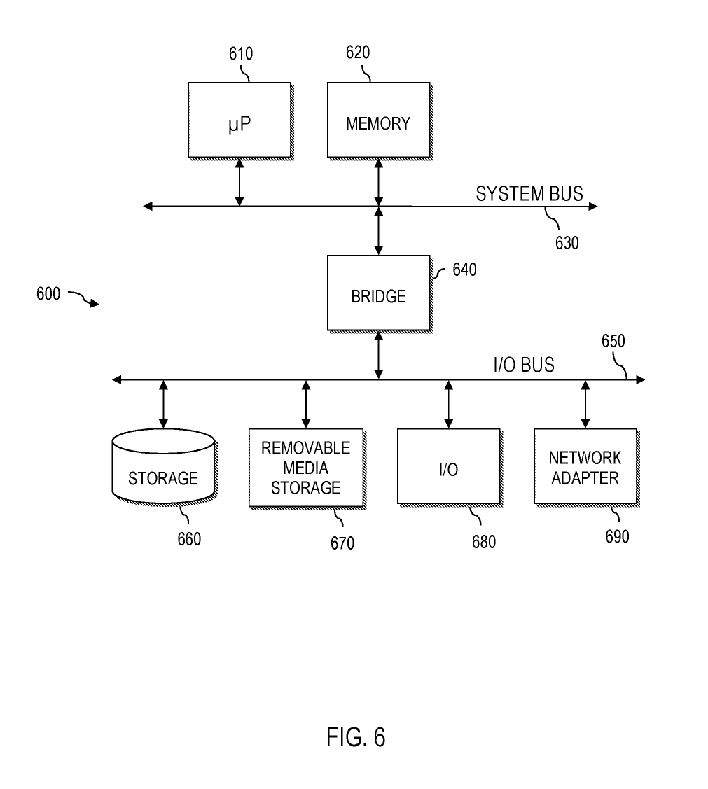

Referring to FIG. 6, a block diagram of a data processing system is depicted in accordance with the present disclosure that may be used as any of the devices described herein (e.g., 502, 512, FIG. 5). Data processing system 600 may comprise a symmetric multiprocessor (SMP) system or other configuration including a plurality of processors 610 connected to system bus 620. Alternatively, a single processor 610 may be employed. Also connected to the system bus 620 is local memory 630. An I/O bus bridge 640 interfaces the system bus 620 to an I/O bus 650. The I/O bus 650 is utilized to support one or more buses and corresponding devices, such as storage 660, removable media storage 670, input/output devices 680, network adapters 690, other devices, combinations thereof, etc. For instance, a network adapter 690 can be used to enable the data processing system 600 to communicate with other data processing systems or remote printers or storage devices through intervening private or public networks.

The memory 630, storage 660, removable media storage 670, or combinations thereof can be used to store program code that is executed by the processor(s) 610 to implement any aspect of the present disclosure described and illustrated in FIGS. 1-5.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable storage medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM), Flash memory, an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device. A computer storage medium does not include propagating signals.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Network using a Network Service Provider).

Aspects of the present disclosure are described herein with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the invention in the form disclosed. Many modifications and variations will be apparent to those of ordinary skill in the art without departing from the scope and spirit of the invention. Aspects of the disclosure were chosen and described in order to best explain the principles of the invention and the practical application, and to enable others of ordinary skill in the art to understand the invention for various embodiments with various modifications as are suited to the particular use contemplated.

What is claimed is:

1. A process for creating an adaptive workout program, the process comprising:
receiving physical characteristic information about a person via a user interface;
receiving goal information via the user interface;
determining a workout program, using artificial intelligence running on a processor and interacting with an electronic database, wherein the workout program is based on the physical characteristic information and the goal information;
retrieving instructions for the workout program;
displaying the instructions for the workout program;
receiving feedback about a performance of the workout program of the person; and
updating the workout program based on the feedback.

2. The process of claim 1, wherein determining a workout program further comprises:
identifying a variable associated with the received physical characteristic information that must be changed to achieve the received goal information;
identifying a first exercise from the database of exercises that modifies the identified variable;
identifying a second exercise from the database of exercises that modifies the identified variable;
adding the first exercise and the second exercise to the workout program.

3. The process of claim 1, wherein:
receiving feedback about a user performance includes receiving the feedback from the user via the user interface; and
updating the workout program includes updating the workout program by:
determining if an exercise of the workout program is too strenuous for the user; and
identifying a less strenuous exercise for the user based on the feedback if the determined exercise is too strenuous.

4. The process of claim 1,
receiving feedback about a user performance includes receiving the feedback from the user via the user interface; and
updating the workout program includes updating the workout program by:
determining if an exercise of the workout program is not strenuous enough for the user; and
identifying a more strenuous exercise for the user based on the feedback if the determined exercise is not strenuous enough.

5. The process of claim 1, wherein receiving feedback about a user performance includes receiving the feedback from sensors placed on the person.

6. The process of claim 5, wherein updating the workout program further comprises:
identifying a variable associated with the received physical characteristic information that must be changed to achieve the received goal information;
identifying an exercise from the database of exercises that modifies the identified variable;
adding the exercise to the workout program.

7. The process of claim 6, wherein updating the exercise to the workout program includes removing a select exercise from the workout program.

8. The process of claim 1, wherein updating the workout program further includes modifying an order of the exercises in the workout program.

9. The process of claim 1 further comprising:
receiving a custom exercise via the user interface;
identifying variables that the custom exercise affects; and
adding the custom exercise to the electronic database for future use.

10. The process of claim 1, wherein receiving physical characteristic information includes receiving physical characteristic information, wherein the physical characteristic information comprises:
information associated with an age of the person;
information associated with a height of the person; or
information associated with a weight of the person.

11. The process of claim 1, wherein receiving physical characteristic information includes receiving physical characteristic information, wherein the physical characteristic information comprises information associated with an injury of the person.

12. The process of claim 1 further comprising receiving sporting information about the person, wherein the sporting information includes a sport and a position of the sport associated with the person;
wherein determining a workout program is further based on the sporting information.

13. The process of claim 1 further comprising receiving equipment access information;
wherein determining a workout program is further based on the equipment access information.

14. The process of claim 1, further comprising receiving availability information;
wherein determining a workout program is further based on the availability information.

15. The process of claim 1, wherein:
retrieving instructions for the workout program further comprises retrieving audio instructions for the workout program; and
displaying the instructions for the workout program further comprises transmitting the audio instructions wirelessly to speakers.

16. The process of claim 1, wherein:
retrieving instructions for the workout program further comprises retrieving video instructions for the workout program; and
displaying the instructions for the workout program further comprises transmitting the video instructions to a screen.

17. The process of claim 1 further comprising displaying a list of exercises of the workout program via the user interface.

18. The process of claim 17 further comprising receiving an override modification to the list of exercises;
wherein updating the workout program further comprises updating the workout program based on the override modification.

19. The process of claim 1, wherein receiving physical characteristic information about a person comprises receiving an image of the person.

20. The process of claim 19, wherein receiving goal information comprises receiving a modified image of the person.
